(19) United States
(12) Patent Application Publication
(10) Pub. No.: US 2007/0206582 A1
(43) Pub. Date: Sep. 6, 2007

(54) VOIP MODEM AND METHOD FOR DETECTING VOIP SERVICE

(75) Inventors: IRAWAN KUNCORO, Tu-Cheng (TW); CHENG-YI HSIEH, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,863

(22) Filed: Dec. 28, 2006

(30) Foreign Application Priority Data
Mar. 3, 2006 (TW) 95107186

(51) Int. Cl. H04L 12/66

(52) U.S. Cl. 370/356

(57) ABSTRACT

A voice over Internet protocol (VoIP) modem (100) includes a service determination module (111), a circuit determination module (112), a line determination module (113), and a command determination module (115). The service determination module determines whether asymmetric digital subscriber line (ADSL) service is available. The circuit determination module determines whether a subscriber line interface circuit (SLIC) chip is normal. The line determination module determines whether a public switched telephone network (PSTN) line is idle. The command determination module determines whether a media gateway control protocol (MGCP) command is successfully exchanged. If ADSL service is available, the SLIC chip is normal, the PSTN line is idle, and the MGCP command is successfully exchanged, the VoIP modem determines that VoIP service is available. A method for detecting whether VoIP service is available is also provided.

### BACKGROUND OF THE INVENTION

1. Field of the Invention

The invention relates to voice over Internet protocol (VoIP), and particularly to a VoIP modem and a method for detecting whether VoIP service is available.

2. Description of Related Art

Due to maturity of asymmetric digital subscriber line (ADSL) technology, ADSL, one of the popular physical communication connection services, is widely used for providing voice over Internet protocol (VoIP) service. Therefore, both VoIP service and public switched telephone network (PSTN) service are available through one phone line.

Although a call charge of VoIP service is cheaper than that of PSTN service, VoIP service is not as stable as PSTN service; for example, VoIP service may be unexpectedly unavailable. A conventional VoIP modem determines whether VoIP service is available according to ADSL service. If ADSL service is available, VoIP service is assumed available. Otherwise, VoIP service is unavailable. However, ADSL service may be available, while VoIP service may not be available. Therefore, the conventional VoIP modem cannot accurately determine whether VoIP service is available by the conventional method.

### SUMMARY OF THE INVENTION

An exemplary embodiment of the present invention provides a voice over Internet protocol (VoIP) modem that detects whether VoIP service is available. The VoIP modem includes a service determination module, a circuit determination module, a line determination module, and a command determination module. The service determination module determines whether asymmetric digital subscriber line (ADSL) service is available. The circuit determination module determines whether a subscriber line interface circuit (SLIC) chip is normal. The line determination module determines whether a public switched telephone network (PSTN) line is idle. The command determination module determines whether a media gateway control protocol (MGCP) command is successfully exchanged. If ADSL service is available, the SLIC chip is normal, the PSTN line is idle, and the MGCP command is successfully exchanged, the VoIP modem determines that VoIP service is available.

Another exemplary embodiment of the present invention provides a method for detecting whether voice over Internet protocol (VoIP) service is available. The method comprises: determining whether asymmetric digital subscriber line (ADSL) service is available; determining whether a subscriber line interface circuit (SLIC) chip is normal if ADSL service is available; determining whether a public switched telephone network (PSTN) line is idle if the SLIC chip is normal; determining whether a media gateway control protocol (MGCP) command is successfully exchanged if the PSTN line is idle; and determining that VoIP service is available if the MGCP command is successfully exchanged.

Other advantages and novel features will become more apparent from the following detailed description when taken in conjunction with the accompanying drawings, in which:

### BRIEF DESCRIPTION OF THE DRAWINGS

FIG. 1 is a schematic diagram of a communication system of an exemplary embodiment of the present invention;

FIG. 2 is a schematic diagram of a communication system of another exemplary embodiment of the present invention;

FIG. 3 is a schematic diagram of functional modules of a voice over Internet protocol (VoIP) modem of an exemplary embodiment of the present invention;

FIG. 4 is a schematic diagram of functional modules of a VoIP modem of another exemplary embodiment of the present invention;

FIG. 5 is a flowchart of a method for detecting VoIP service of a further exemplary embodiment of the present invention;

FIG. 6 is a flowchart of a method for detecting VoIP service of a still further exemplary embodiment of the present invention; and

FIG. 7 is a flowchart of a method for determining whether a gateway is reachable of FIG. 6.

### DETAILED DESCRIPTION OF THE INVENTION

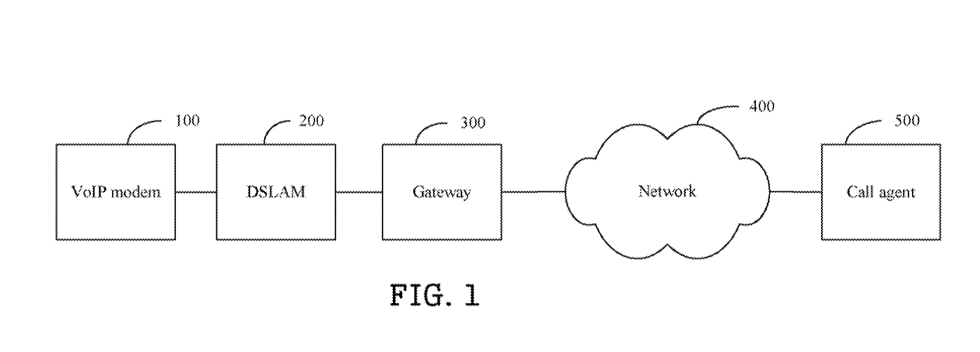

FIG. 1 is a schematic diagram of a communication system of an exemplary embodiment of the present invention. In the exemplary embodiment, the communication system includes a voice over Internet protocol (VoIP) modem 100, a digital subscriber line access multiplexer (DSLAM) 200, a gateway 300, a network 400, and a call agent 500. The VoIP modem 100 is connected to the DSLAM 200 via a PSTN line, and then the gateway 300 is connected to the call agent 500 via the network 400.

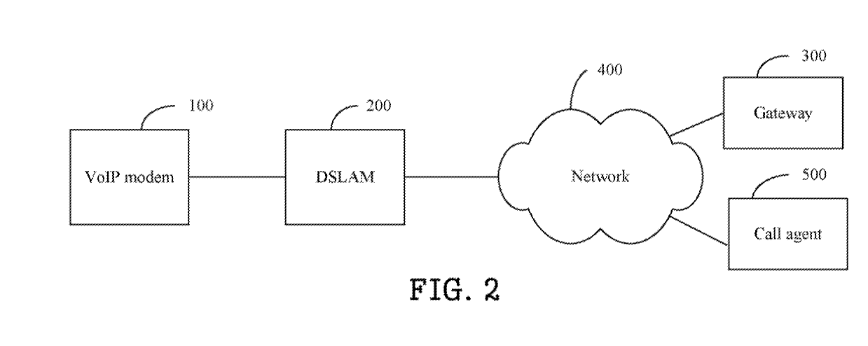

In another exemplary embodiment, referring to FIG. 2, the VoIP modem 100 may be connected to the DSLAM 200 via the PSTN line, and then the DSLAM 200 is connected to the gateway 300 and the call agent 500 via the network 400.

The DSLAM 200 provides a physical communication connection service like an ADSL service for the VoIP modem 100. The gateway 300 provides intercommunication between VoIP calls and PSTN calls for the VoIP modem 100. The call agent 500 provides VoIP service for the VoIP modem 100. Therefore, the VoIP modem 100 can provide PSTN service via the PSTN line, and provide VoIP service via the PSTN line, the DSLAM 200, the gateway 300, the network 400, and the call agent 500.

In the exemplary embodiment, the VoIP modem 100 may be an integrated access device (IAD). The VoIP modem 100 can detect whether VoIP service is available when booting up, and/or periodically detect whether VoIP service is available after booting up. The VoIP modem 100 can accurately detect whether VoIP service is available by determining whether ADSL service is available, whether a subscriber line interface circuit (SLIC) chip is normal, whether the PSTN line is idle, and whether a media gateway control protocol (MGCP) command is successfully exchanged. If ADSL service is available, the SLIC chip is normal, the PSTN line is idle, and the MGCP command is successfully exchanged, the VoIP modem 100 determines that VoIP service is available. Otherwise, the VoIP modem 100 determines that VoIP service is unavailable. When VoIP service is unavailable, the VoIP modem 100 will provide PSTN service instead of VoIP service, thereby avoiding missing some urgent calls.

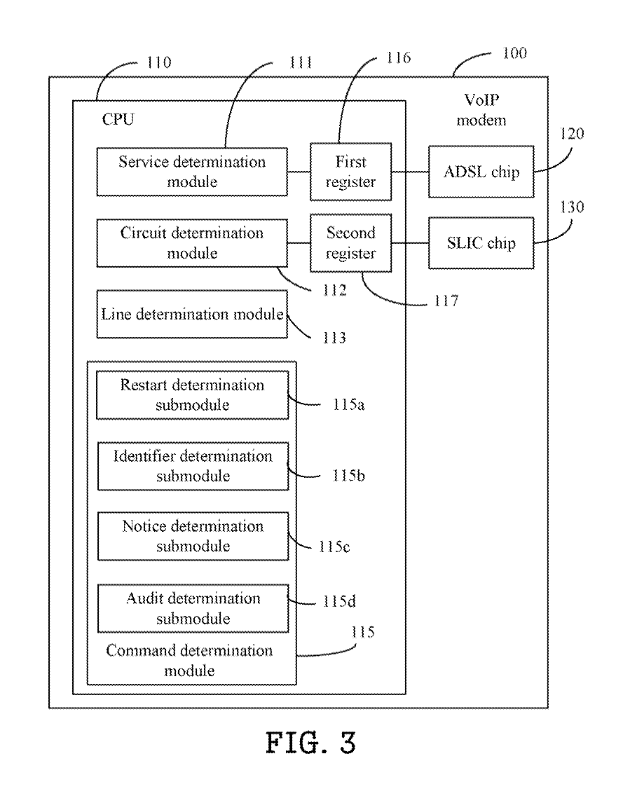

FIG. 3 is a schematic diagram of functional modules of the VoIP modem 100 of an exemplary embodiment of the present invention. In the exemplary embodiment, the VoIP modem 100 includes a central processing unit (CPU) 110, an ADSL chip 120, and a SLIC chip 130. The CPU 110 detects whether VoIP service is available. The CPU 110 includes a service determination module 111, a circuit determination module 112, a line determination module 113, a command determination module 115, a first register 116, and a second register 117. The ADSL chip 120 provides ADSL service for the VoIP modem 100 by communicating with the DSLAM 200.

The service determination module 111 determines whether ADSL service is available. In the exemplary embodiment, when the VoIP modem 100 boots up, the ADSL chip 120 communicates with the DSLAM 200. When successfully communicating with the DSLAM 200, the ADSL chip 120 stores a default value, for example, a number 1, in the first register 116. When unsuccessfully communicating with the DSLAM 200, the ADSL chip 120 stores another default value, for example, a number 0, in the first register 116. The service determination module 111 reads the default value from the first register 116, and determines whether ADSL service is available according to the default value. If the default value is 1, ADSL service is available. If the default value is 0, ADSL service is unavailable. In such case, the service determination module 111 determines that VoIP service is unavailable.

In other embodiments, the service determination module 111 may employ different methods to determine whether ADSL service is available according to different designs of the ADSL chip 120.

If ADSL service is available, the circuit determination module 112 determines whether the SLIC chip 130 is normal. In the exemplary embodiment, when the VoIP modem 100 boots up, the CPU 110 reads a version of the SLIC chip 130. When the version of the SLIC chip 130 is correctly read, the SLIC chip 130 is normal. In such case, the SLIC chip 130 stores a default value, for example, a number 1, in the second register 117. When the version of the SLIC chip 130 is incorrectly read, the SLIC chip 130 is abnormal. In such case, the SLIC chip 130 stores another default value, for example, a number 0, in the second register 117. The circuit determination module 112 reads the default value from the second register 117, and determines whether the SLIC chip 130 is normal according to the default value. If the default value is 1, the SLIC chip 130 is normal. If the default value is 0, the SLIC chip 130 is abnormal. In such case, the circuit determination module 112 determines that VoIP service is unavailable.

In other embodiments, the circuit determination module 112 may employ different methods to determine whether the SLIC chip 130 is normal according to different designs of the SLIC chip 130.

If the SLIC chip 130 is normal, the line determination module 113 determines whether the PSTN line is idle. In the exemplary embodiment, the line determination module 113 determines whether the PSTN line is idle by determining whether a loop current is detected. If a loop current is detected, the line determination module 113 determines that the PSTN line is busy. In such case, the line determination module 113 determines that VoIP service is unavailable. If no loop current is detected, the line determination module 113 determines that the PSTN line is idle.

If the PSTN line is idle, the command determination module 115 determines whether an MGCP command is successfully exchanged. If the MGCP command is unsuccessfully exchanged, the command determination module 115 determines that VoIP service is unavailable. If the MGCP command is successfully exchanged, the command determination module 115 determines that VoIP service is available.

In other embodiments, determination sequences of the service determination module 111, the circuit determination module 112, the line determination module 113, and the command determination 115 may be exchanged.

In the exemplary embodiment, the MGCP command includes a restart in progress (RSIP) command, a notify (NTFY) command, and an audit endpoint (AUEP) command. The command determination module 115 includes a restart determination submodule 115a, an identifier determination submodule 115b, a notice determination submodule 115c, and an audit determination submodule 115d.

The restart determination submodule 115a sends a RSIP command to the call agent 500, and determines whether a RSIP response is received from the call agent 500. The RSIP response includes an endpoint identifier (EPT ID). If no RSIP response is received from the call agent 500, the restart determination module 115a determines that the MGCP command is unsuccessfully exchanged, namely determining that VoIP service is unavailable.

If a RSIP response is received from the call agent 500, the identifier determination submodule 115b determines whether the EPT ID included in the RSIP response is valid. In the exemplary embodiment, the identifier determination submodule 115b determines whether the EPT ID included in the RSIP response is valid by determining whether the EPT ID included in the RSIP response is the same as an EPT ID of the VoIP modem 100. If the EPT ID included in the RSIP response is the same as the EPT ID of the VoIP modem 100, the EPT ID included in the RSIP response is valid. If the EPT ID included in the RSIP response is not the same as the EPT ID of the VoIP modem 100, the EPT ID included in the RSIP response is invalid. In such case, the identifier determination submodule 115b determines that the MGCP command is unsuccessfully exchanged, namely determining that VoIP service is unavailable.

If the EPT ID included in the RSIP response is valid, the notice determination submodule 115c sends a NTFY command to the call agent 500, and determines whether a NTFY response is received from the call agent 500. If no NIFY response is received from the call agent 500, the notice determination submodule 115c determines that the MGCP command is unsuccessfully exchanged, namely determining that VoIP service is unavailable.

If a NIFY response is received from the call agent 500, the audit determination submodule 115d determines whether an AUEP command is received from the call agent 500. If an AUEP command is received from the call agent 500, the audit determination submodule 115d determines that the MGCP command is successfully exchanged, namely determining that VoIP service is available. If no AUEP command is received from the call agent 500, the audit determination submodule 115d determines that the MGCP command is unsuccessfully exchanged, namely determining that VoIP service is unavailable.

In other embodiments, determination sequences of the restart determination submodule 115a, the notice determination submodule 115c, and the audit determination submodule 115d may be exchanged, but the action of the identifier determination submodule 115b must be followed by that of the restart determination submodule 115a.

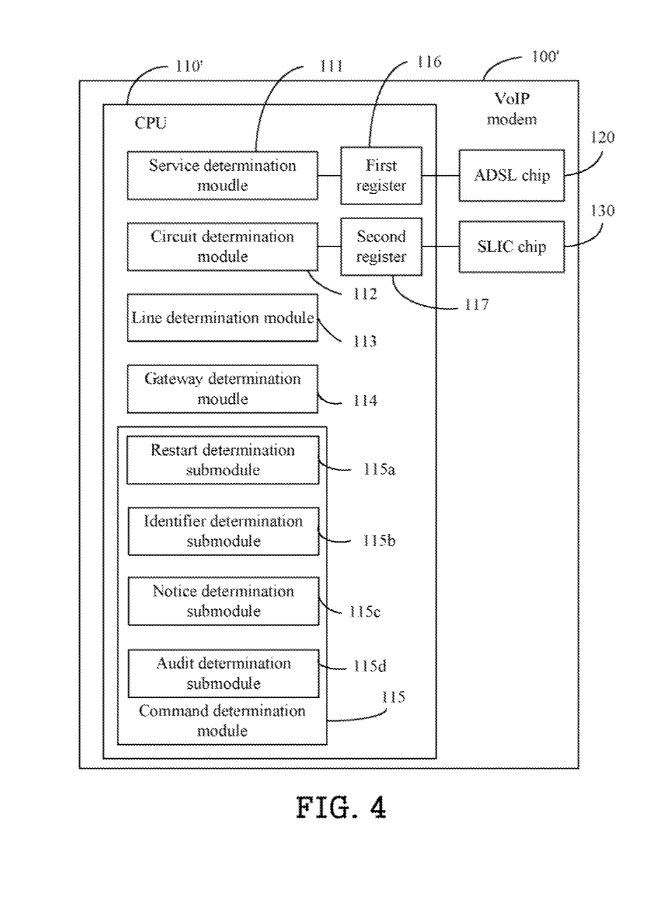

FIG. 4 is a schematic diagram of functional modules of the VoIP modem 100′ of another exemplary embodiment of the present invention. In the exemplary embodiment, the VoIP modem 100′ more accurately determines whether VoIP service is available by determining whether the gateway 300 is reachable. The CPU 100′ further includes a gateway determination module 114, and other modules are the same as those of the VoIP modem 100.

The gateway determination module 114 determines whether the gateway 300 is reachable. In the exemplary embodiment, the gateway determination module 114 transmits an Internet control message protocol (ICMP) echo request to the gateway 300, and determines whether the gateway 300 is reachable by determining whether an ICMP echo reply is received from the gateway 300. If an ICMP echo reply is received from the gateway 300, the gateway determination module 114 determines that the gateway 300 is reachable. If no ICMP echo reply is received from the gateway 300, the gateway determination module 114 transmits another ICMP echo request to the gateway 300. If the number of times for transmitting the ICMP echo request reaches a default number of times, and no ICMP echo reply is received from the gateway 300, the gateway determination module 114 determines that the gateway 300 is unreachable. In the exemplary embodiment, the default number of times is set to 4 times. In other embodiments, the number of times for transmitting the ICMP echo request may be varied according to different requirements.

In the exemplary embodiment, the gateway determination module 114 determines whether the gateway 300 is reachable, after the line determination module 113 determines that the PSTN line is idle. If the gateway 300 is unreachable, the gateway determination module 114 determines that VoIP service is unavailable. If the gateway 300 is reachable, the command determination module 115 determines whether the MGCP command is successfully exchanged to determine whether VoIP service is available.

In other embodiments, determination sequences of the service determination module 111, the circuit determination module 112, the line determination module 113, the gateway determination module 114, and the command determination module 115 may be exchanged.

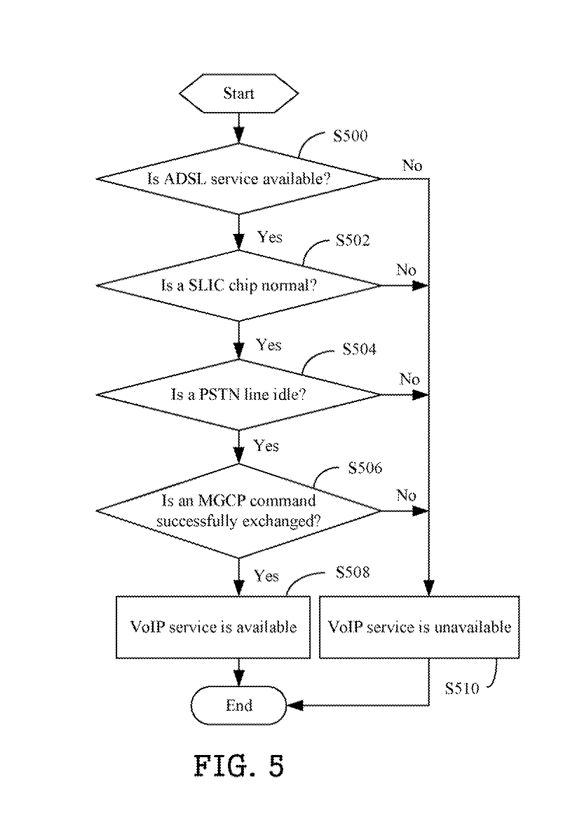

FIG. 5 is a flowchart of a method for detecting VoIP service of an exemplary embodiment of the present invention. In the exemplary embodiment, the VoIP modem 100 accurately detects whether VoIP service is available.

In step S500, the VoIP modem 100 determines whether ADSL service is available. If ADSL service is unavailable, in step S510, the VoIP modem 100 determines that VoIP service is unavailable. If ADSL service is available, in step S502, the VoIP modem 100 determines whether the SLIC chip 130 is normal.

If the SLIC chip 130 is abnormal, in step S510, the VoIP modem 100 determines that VoIP service is unavailable. If the SLIC chip 130 is normal, in step S504, the VoIP modem 100 determines whether a PSTN line is idle.

If the PSTN line is busy, in step S510, the VoIP modem 100 determines that VoIP service is unavailable. If the PSTN line is idle, in step S506, the VoIP modem 100 determines whether the MGCP command is successfully exchanged.

If the MGCP command is unsuccessfully exchanged, in step S510, the VoIP modem 100 determines that VoIP service is unavailable. If the MGCP command is successfully exchanged, in step S508, the VoIP modem 100 determines that VoIP service is available. Thus, the VoIP modem 100 accurately detects whether VoIP service is available.

In other embodiments, sequences of the steps S500, S502, S504, and S506 may be exchanged.

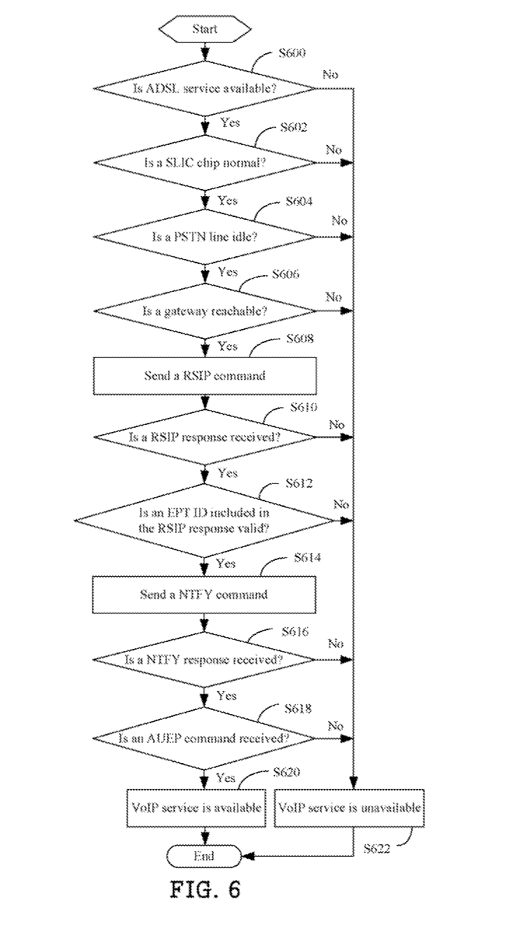

FIG. 6 is a flowchart of a method for detecting VoIP service of another exemplary embodiment of the present invention. In the exemplary embodiment, the VoIP modem 100′ more accurately detects whether VoIP service is available.

In step S600, the service determination module 111 determines whether ADSL service is available. In the exemplary embodiment, the service determination module 111 determines whether ADSL service is available according to a default value from the first register 116. When the VoIP modem 100′ boots up, the ADSL chip 120 communicates with the DSLAM 200. When successfully communicating with the DSLAM 200, the ADSL chip 120 stores a default value, for example, a number 1, in the first register 116. When communicating with the DSLAM 200 is unsuccessful, the ADSL chip 120 stores another default value, for example, a number 0, in the first register 116. Therefore, the service determination module 111 reads the default value from the first register 116, and determines whether ADSL service is available according to the default value. If the default value is 1, ADSL service is available. If the default value is 0, ADSL service is unavailable.

In other embodiments, the service determination module 111 may employ different methods to determine whether ADSL service is available according to different designs of the ADSL chip 120.

If ADSL service is unavailable, in step S622, the service determination module 111 determines that VoIP service is unavailable.

If ADSL service is available, in step S602, the circuit determination module 112 determines whether the SLIC chip 130 is normal. In the exemplary embodiment, the circuit determination module 112 determines whether the SLIC chip 130 is normal according to a default value from the second register 117. When the VoIP modem 100 boots up, the CPU 110 reads a version of the SLIC chip 130. When the version of the SLIC chip 130 is correctly read, the SLIC chip 130 is normal. In such case, the SLIC chip 130 stores a default value, for example, a number 1, in the second register 117. When the version of the SLIC chip 130 is incorrectly read, the SLIC chip 130 is abnormal. In such case, the SLIC chip 130 stores another default value, for example, a number 0, in the second register 117. Therefore, the circuit determination module 112 reads the default value from the second register 117, and determines whether the SLIC chip 130 is normal according to the default value. If the default value is 1, the SLIC chip 130 is normal. If the default value is 0, the SLIC chip 130 is abnormal.

In other embodiments, the circuit determination module 112 may employ different methods to determine whether the SLIC chip 130 is normal according to different designs of the SLIC chip 130.

If the SLIC chip 130 is abnormal, in step S622, the circuit determination module 112 determines that VoIP service is unavailable.

If the SLIC chip 130 is normal, in step S604, the line determination module 113 determines whether the PSTN line is idle. In the exemplary embodiment, the line determination module 113 determines whether the PSTN line is idle by determining whether a loop current is detected. If a loop current is detected, the line determination module 113 determines that the PSTN line is busy. If no loop current is detected, the line determination module 113 determines that the PSTN line is idle.

If the PSTN line is busy, in step S622, the line determination module 113 determines that VoIP service is unavailable.

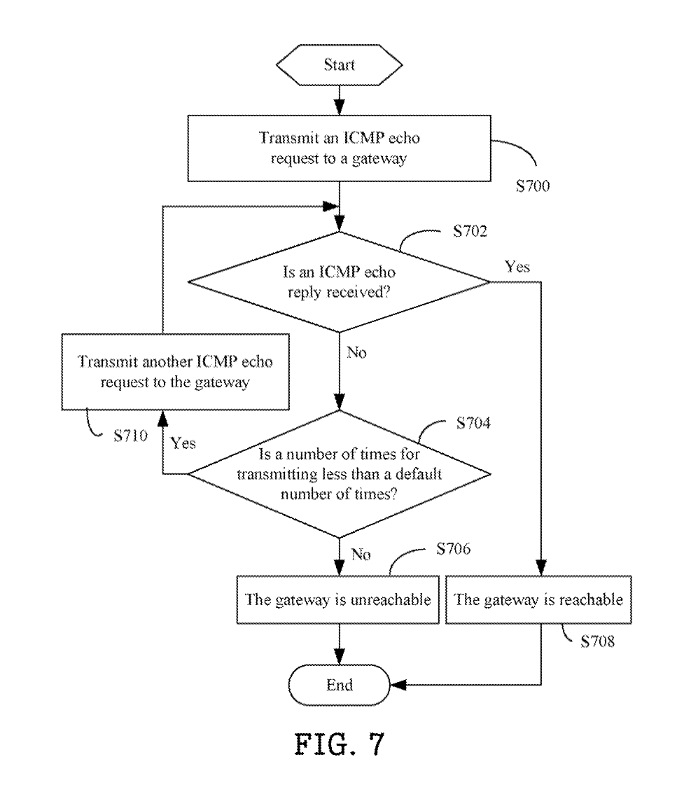

If the PSTN line is idle, in step S606, the gateway determination module 114 determines whether the gateway 300 is reachable. The details of a method for determining whether the gateway 300 is reachable are described in FIG. 7.

If the gateway 300 is unreachable, in step S622, the gateway determination module 114 determines that VoIP service is unavailable.

If the gateway 300 is reachable, in step S608, the restart determination submodule 115a sends a RSIP command to the call agent 500.

In step S610, the restart determination submodule 115a determines whether a RSIP response is received from the call agent 500. The RSIP response includes an endpoint identifier (EPT ID).

If no RSIP response is received from the call agent 500, in step S622, the restart determination submodule 115a determines that VoIP service is unavailable.

If a RSIP response is received from the call agent 500, in step S612, the identifier determination submodule 115b determines whether the EPT ID included in the RSIP response is valid. In the exemplary embodiment, the identifier determination submodule 115b determines whether the EPT ID included in the RSIP response is valid by determining whether the EPT ID included in the RSIP response is the same as the EPT ID of the VoIP modem 100′. If the EPT ID included in the RSIP response is the same as the EPT ID of the VoIP modem 100′, the EPT ID included in the RSIP response is valid. If the EPT ID included in the RSIP response is not the same as the EPT ID of the VoIP modem 100′, the EPT ID included in the RSIP response is invalid.

If the EPT ID included in the RSIP response is invalid, in step S622, the identifier determination module 115b determines that VoIP service is unavailable.

If the EPT ID included in the RSIP response is valid, in step S614, the notice determination submodule 115c sends a NTFY command to the call agent 500.

In step S616, the notice determination submodule 115c determines whether a NTFY response is received from the call agent 500.

If no NTFY response is received from the call agent 500, in step S622, the notice determination submodule 115c determines that VoIP service is unavailable.

If a NEFY response is received from the call agent 500, in step S618, the audit determination submodule 115d determines whether an AUEP command is received from the call agent 500.

If an AUEP command is received from the call agent 500, in step S620, the audit determination submodule 115d determines that VoIP service is available.

If no AUEP command is received from the call agent 500, in step S622, the audit determination submodule 115d determines that VoIP service is unavailable.

In other embodiments, sequences of the steps S610, S616, and S618 may be exchanged, but step S610 must be performed after step S608, step S612 must be performed after step S610, and step S616 must be performed after step S614.

FIG. 7 is a flowchart of a method for determining whether the gateway 300 is reachable of FIG. 6.

In step S700, the gateway determination module 114 transmits an ICMP echo request to the gateway 300.

In step S702, the gateway determination module 114 determines whether an ICMP echo reply is received from the gateway 300.

If an ICMP echo reply is received from the gateway 300, in step S708, the gateway determination module 114 determines that the gateway 300 is reachable.

If no ICMP echo reply is received from the gateway 300, in step S704, the gateway determination module 114 determines whether the number of times for transmitting the ICMP echo request is less than a default number of times. In the exemplary embodiment, the default number of times is set to 4 times. In other embodiments, the number of times for transmitting the ICMP echo request may be varied according to different requirements.

If the number of times for transmitting the ICMP echo request is not less than the default number of times, in step S706, the gateway determination module 114 determines that the gateway 300 is unreachable.

If the number of times for transmitting the ICMP echo request is less than the default number of times, in step S710, the gateway determination module 114 transmits another ICMP echo request to the gateway 300. Then, going back to step S702, the gateway determination module 114 determines whether an ICMP echo reply is received from the gateway 300.

Thus, the VoIP modem 100′ of this embodiment accurately detects whether VoIP service is available by determining whether ADSL service is available, whether the SLIC chip 130 is normal, whether the PSTN line is idle, whether the gateway 300 is reachable, and whether the MGCP command is successfully exchanged. If ADSL service is available, the SLIC chip 130 is normal, the PSTN line is idle, the gateway 300 is reachable, and the MGCP command is successfully exchanged, the VoIP modem 100′ determines that VoIP service is available. Otherwise, the VoIP modem 100′ determines that VoIP service is unavailable. When VoIP service is unavailable, the VoIP modem 100′ will provide PSTN service instead of VoIP service, thereby avoiding missing some urgent calls.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A voice over Internet protocol (VoIP) modem, comprising:
a service determination module, for determining whether asymmetric digital subscriber line (ADSL) service is available;
a circuit determination module, for determining whether a subscriber line interface circuit (SLIC) chip is normal;
a line determination module, for determining whether a public switched telephone network (PSTN) line is idle; and
a command determination module, for determining whether a media gateway control protocol (MGCP) command is successfully exchanged;
wherein if ADSL service is available, the SLIC chip is normal, the PSTN line is idle, and the MGCP command is successfully exchanged, the VoIP modem determines that VoIP service is available.

2. The VoIP modem as claimed in claim 1, further comprising a gateway determination module, for determining whether a gateway is reachable.

3. The VoIP modem as claimed in claim 2, wherein the gateway determination module transmits an Internet control message protocol (ICMP) echo request to the gateway, and determines whether the gateway is reachable by determining whether an ICMP echo reply is received from the gateway.

4. The VoIP modem as claimed in claim 1, further comprising a register and an ADSL chip for storing a default value in the register, and the service determination module determines whether ADSL service is available according to the default value from the register.

5. The VoIP modem as claimed in claim 1, further comprising a register and the SLIC chip for storing a default value in the register, and the circuit determination module determines whether the SLIC chip is normal according to the default value from the register.

6. The VoIP modem as claimed in claim 1, wherein the line determination module determines whether the PSTN line is idle by determining whether a loop current is detected.

7. The VoIP modem as claimed in claim 1, wherein the MGCP command comprises a restart in progress (RSIP) command, and the command determination module comprises a restart determination submodule, for sending a RSIP command to a call agent and determining whether a RSIP response is received from the call agent.

8. The VoIP modem as claimed in claim 7, wherein the RSIP response comprises an endpoint identifier (EPT ID), and the command determination module further comprises an identifier determination submodule, for determining whether the EPT ID in the RSIP response is valid.

9. The VoIP modem as claimed in claim 8, wherein the identifier determination submodule determines whether the EPT ID in the RSIP response is valid by determining whether the EPT ID in the RSIP response is the same as an EPT ID of the VoIP modem.

10. The VoIP modem as claimed in claim 1, wherein the MGCP command comprises a notify (NTFY) command, and the command determination module comprises a notice determination submodule, for sending an NTFY command to a call agent and determining whether a NTFY response is received from the call agent.

11. The VoIP modem as claimed in claim 1, wherein the MGCP command comprises an audit endpoint (AUEP) command, and the command determination module comprises an audit determination submodule, for determining whether an AUEP command is received from a call agent.

12. A method for detecting whether voice over Internet protocol (VoIP) service is available, comprising:
determining whether asymmetric digital subscriber line (ADSL) service is available;
determining whether a subscriber line interface circuit (SLIC) chip is normal if ADSL service is available;
determining whether a public switched telephone network (PSTN) line is idle if the SLIC chip is normal;
determining whether a media gateway control protocol (MGCP) command is successfully exchanged if the PSTN line is idle; and
determining that VoIP service is available if the MGCP command is successfully exchanged.

13. The method as claimed in claim 12, further comprising:
providing a gateway;
transmitting an Internet control message protocol (ICMP) echo request to the gateway;
determining whether an ICMP echo reply is received from the gateway; and
determining that the gateway is reachable if the ICMP echo reply is received.

14. The method as claimed in claim 13, further comprising:
determining whether the number of times for transmitting the ICMP echo request is less than a default number of times if no ICMP echo reply is received; and
determining that the gateway is unreachable if the number of times for transmitting the ICMP echo request is not less than the default number of times.

15. The method as claimed in claim 12, wherein the step of determining whether the PSTN line is idle comprises:
determining whether a loop current is detected; and
determining that the PSTN line is idle if the loop current is detected.

16. The method as claimed in claim 12, wherein the step of determining whether an MGCP command is successfully exchanged comprises:
providing a call agent;
sending a restart in progress (RSIP) command to the call agent;
determining whether a RSIP response from the call agent;
determining whether an endpoint identifier (EPT ID) in the RSIP response is valid if the RSIP response is received from the call agent;
sending a notify (NTFY) command to the call agent if the EPT ID in the RSIP is valid;
determining whether a NTFY response is received from the call agent;
determining whether an audit endpoint (AUEP) command is received from the call agent if the NTFY response is received from the call agent; and
determining that VoIP service is available if the AUEP command is received from the call agent.

17. A method for detecting availability of voice over Internet protocol (VoIP) service, comprising steps of:
detecting availability of physical communication connection service;
determining normality of a subscriber line interface circuit (SLIC) chip when said physical communication connection service is available; and
detecting exchange of a media gateway control protocol (MGCP) command through said physical communication connection service when said SLIC chip is normal; and
determining VoIP service is available through said physical communication connection service when said MGCP command is successfully exchanged.
